(19) United States
(12) Patent Application Publication
(10) Pub. No.: US 2022/0214801 A1
(43) Pub. Date: Jul. 7, 2022

(54) METHODS AND SYSTEMS FOR MODIFYING USER INPUT PROCESSES

(71) Applicants: Typewise Ltd., Binningen (CH); ETH Zürich, Zürich (CH)

(72) Inventors: Janis Berneker, Zürich (CH); David Eberle, Basel (CH); George Roberts, Zürich (CH)

(21) Appl. No.: 17/568,212

(22) Filed: Jan. 4, 2022

Related U.S. Application Data
(60) Provisional application No. 63/134,347, filed on Jan. 6, 2021.

(51) Int. Cl. G06F 3/04886; G10L 15/00

(52) U.S. Cl. CPC G06F 3/04886; G10L 15/005

(57) ABSTRACT

A method for recommending modification of user input includes receiving, by a graphical user interface (GUI) provided by a virtual keyboard application, user input representing a first word entered by a user. The virtual keyboard application accesses at least one word entered by the user prior to the entering of the first word. The virtual keyboard application determines an edit distance between the first word and each of a plurality of candidate modifications, based on analyzing the first word, the touchpoint and the at least one word entered prior to the entering of the first word, the plurality of candidate modifications selected from a dictionary in a language matching a language of the first word. The virtual keyboard application identifies a subset of the plurality of candidate modifications. The virtual keyboard application modifies the GUI to display at least one of the identified subset.

### CROSS-REFERENCE TO RELATED APPLICATIONS

This application claims priority from U.S. Provisional Patent Application No. 63/134,347, filed on Jan. 6, 2021, entitled, “Methods and Systems for Modifying User Input Processes,” which is hereby incorporated by reference.

### BACKGROUND

The disclosure relates to interacting with software applications. More particularly, the methods and systems described herein relate to functionality for improving data entry into a user interface of a software application by modifying the processes by which users provide user input to the software application.

Conventional user interfaces for entering data into software applications (which may be referred to as “soft” keyboards or “virtual” keyboards) typically lack functionality for improving a level of accuracy of user input to the user interface. Data input into conventional mobile devices is approximately lox slower than human thinking and error-prone; therefore, it is typically highly inefficient. Conventional desktop interfaces for entering data via physical keyboards face similar challenges. Furthermore, conventional approaches to improving user interfaces often require that a user agrees to having some or all of the user input transmitted to a third-party computing device to access functionality for improving accuracy of user input, which may present unacceptable security risks to users concerned with data privacy.

Therefore, there is a need for technical tools that improve processes by which such user interfaces receive user input.

### BRIEF SUMMARY

In one aspect, a computer-implemented method for generating and displaying a recommendation for modification of user input includes receiving, by a graphical user interface provided by a virtual keyboard application executing on a computing device, user input representing a first word entered by a user of the computing device, the first word including at least one character. The method includes determining, by the virtual keyboard application, that the user has completed entering the word. The method includes identifying, by the virtual keyboard application, a touchpoint within the graphical user interface associated with the at least one character. The method includes accessing, by the virtual keyboard application, at least one word entered by the user prior to the entering of the first word. The method includes determining, by the virtual keyboard application, an edit distance between the first word and each of a plurality of candidate modifications, based on analyzing the first word, the touchpoint and the at least one word entered prior to the entering of the first word, the plurality of candidate modifications selected from a dictionary in a language matching a language of the first word. The method includes identifying, by the virtual keyboard application, a subset of the plurality of candidate modifications, each of the subset associated with a confidence score that satisfies a threshold level of confidence. The method includes modifying, by the virtual keyboard application, the graphical user interface to include a display of at least one of the identified subset associated with the confidence score that satisfies a threshold level of confidence.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a flow diagram depicting an embodiment of a method for modifying user input processes;

FIG. 1B is a flow diagram depicting an embodiment of a method for modifying user input processes;

FIG. 2 is a block diagram depicting an embodiment of a system for modifying user input processes;

FIG. 3 is a flow diagram depicting an embodiment of a method for modifying user input processes; and

FIGS. 4A-4C are block diagrams depicting embodiments of computers useful in connection with the methods and systems described herein.

### DETAILED DESCRIPTION

In one aspect, the methods and systems described herein provide autocorrection functionality leveraging artificial intelligence (e.g., via a machine learning engine) to improve a rate of user input by detecting what the user wants to input and by learning how the user communicates (especially given that how users communicates and what kind of information is input into a user's computing device varies significantly from person to person). In a keyboard context, people use different words, different word-combinations, and have different typing behavior (e.g., touch locations, typing speed); the methods and systems described herein use this type of information to better interpret what the user intends to input. One application of this technology is a virtual smartphone keyboard. Other applications may include functionality to enhance input through hardware keyboards, voice-to-text, wearables (e.g., smartwatches or smart glasses), and brain-computer-interfaces.

In one aspect, the autocorrection functionality provided by the methods and systems described herein provides support for users who speak and enter data in multiple languages, something that's common across the globe (e.g., a user speaks Spanish at home and English at work, or a user sends Short Message Service text messages to one message recipient in one language but to another message recipient in another language). Typical autocorrections fail in such embodiments, because they typically try to correct, for example, a Spanish word into a similar-looking English word, which leads to increased errors and higher levels of inefficiency and user frustration.

In one aspect, the autocorrection functionality provided by the methods and systems described herein provides support for users who enter data into computing devices that includes words in slang, dialects, etc., including data used by countries (e.g., Arabic speaking countries), population groups (e.g., teenagers), and other groups of people (e.g., language in use by an enterprise or company). Traditional autocorrections use standard language dictionaries, and then force the user into accepting replacements of user-entered data with standard word usage or go through the process of rejecting the autocorrection. The methods and systems described herein adapt to a user's language style by analyzing user-entered data and generating autocorrect recommendations and/or automatically correcting a user's data input when a level of confidence in the recommended correction exceeds a threshold level of confidence.

In another aspect, the autocorrection functionality provided by the methods and systems described herein provides support for users executes on the computing device of the user (e.g., “offline” or “on-device”). This results in personalization to data input received from a user occurs locally on the user's computing device, which provides an increased level of privacy to the user over conventional systems, which often require that the user authorize transmission of their data (including personal or confidential data, such as banking passwords, healthcare identifiers, and other personal data) over one or more computer networks to third party computers where the computation occurs, all of which decreases the user's privacy.

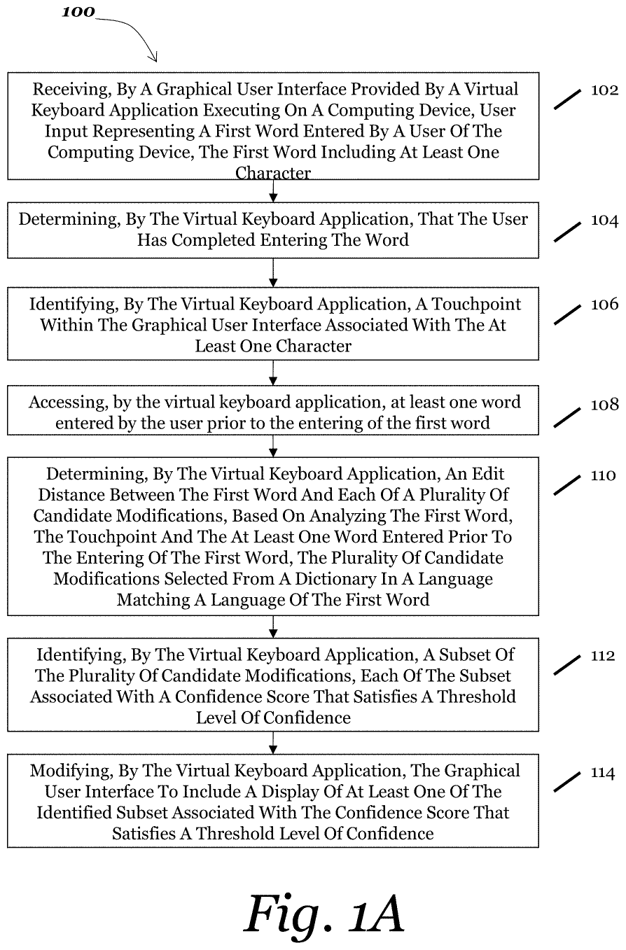

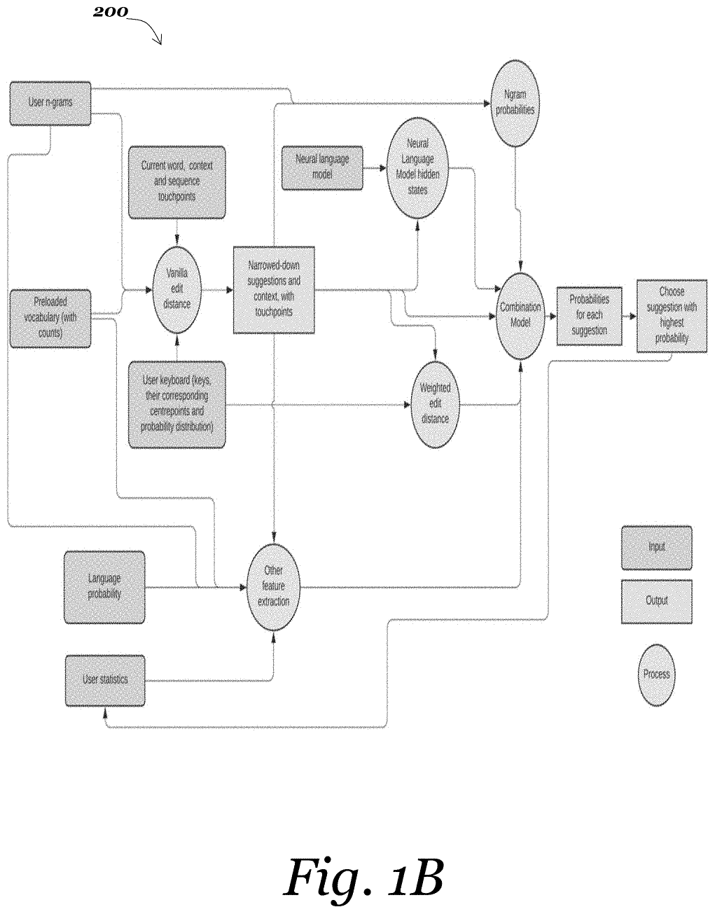

The methods and systems described herein may include functionality for generating suggestions to users for automatically correcting (“autocorrecting”) a word received as user input. Referring now to FIG. 1A, in brief overview, a flow diagram depicts one embodiment of a method 100 for generating and displaying a recommendation for modification of user input. The computer-implemented method 100 for generating and displaying a recommendation for modification of user input includes receiving, by a graphical user interface provided by a virtual keyboard application executing on a computing device, user input representing a first word entered by a user of the computing device, the first word including at least one character (102). The method includes determining, by the virtual keyboard application, that the user has completed entering the word (104). The method includes identifying, by the virtual keyboard application, a touchpoint within the graphical user interface associated with the at least one character (106). The method includes accessing, by the virtual keyboard application, at least one word entered by the user prior to the entering of the first word (108). The method includes determining, by the virtual keyboard application, an edit distance between the first word and each of a plurality of candidate modifications, based on analyzing the first word, the touchpoint and the at least one word entered prior to the entering of the first word, the plurality of candidate modifications selected from a dictionary in a language matching a language of the first word (110). The method includes identifying, by the virtual keyboard application, a subset of the plurality of candidate modifications, each of the subset associated with a confidence score that satisfies a threshold level of confidence (112). The method includes modifying, by the virtual keyboard application, the graphical user interface to include a display of at least one of the identified subset associated with the confidence score that satisfies a threshold level of confidence (114).

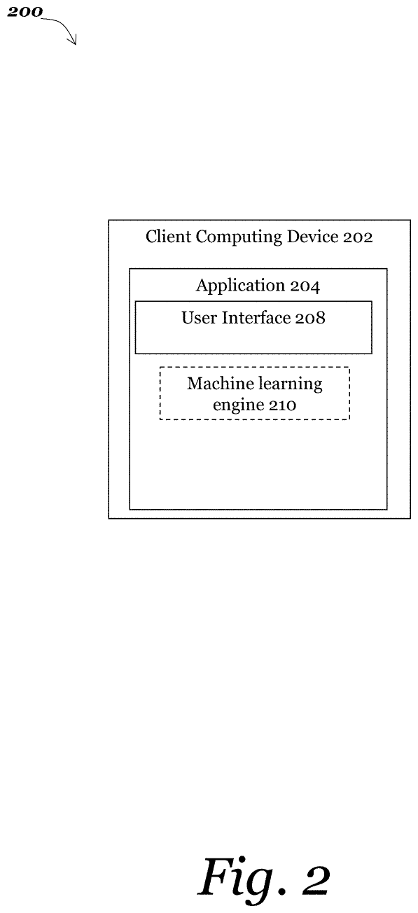

Referring now to FIG. 1A, in greater detail and in connection with FIG. 1B and FIG. 2, a flow diagram depicts one embodiment of a method 100 for generating and displaying a recommendation for modification of user input. The computer-implemented method 100 for generating and displaying a recommendation for modification of user input includes receiving, by a graphical user interface provided by a virtual keyboard application executing on a computing device, user input representing a first word entered by a user of the computing device, the first word including at least one character (102).

In one embodiment, when a user interacts with an application on a computing device that requires text input, the application may display a virtual keyboard interface; when the user touches a display screen of the computing device to touch a portion of the screen displaying a portion of the virtual keyboard interface (e.g., in order to “type” into the interface); and an operating system of the computing device transmits to the virtual keyboard interface information about the user's touchpoint on the screen (e.g., x,y coordinates representing the user's touch on the screen, hold duration, movement path). The application may use the information about the user's touchpoint on the screen to identify a character associated with the touchpoint. The application may execute an autocorrection method, using as input the touchpoints pressed (as well as, in some embodiments, information about touchpoints pressed prior to the touchpoint most recently pressed), with their corresponding characters, with context information and with the user's past behavior. Coordinates identifying where on a screen of a device a user touched and whether they swiped whilst pressing (including the movement path along which they swipe), along with the start and end timestamp of the touch, may be referred to as touchpoints.

Words that are considered to be “real” or valid words by the system may be referred to as a vocabulary. This may include a preloaded vocabulary within an application as well as user-specified or other additional user-words.

A sequence of n elements in a sequence may be referred to as an n-gram. In one embodiment, n-grams include unigrams [one-word with no context, e.g., (‘this’), (‘is’), (‘an’), (‘example’)] and bigrams [two-word sequences, e.g., (‘this’, ‘is’), (‘is’, ‘an’), (‘an’, ‘example’)].

Inputs to the system 200 may include user n-grams. This may include at least two dictionaries—unigrams and bigrams, which are completely built on the user's device (the start value may be empty). Each entry also contains the language that was being typed when the word was entered. When a user types a word they haven't typed before, the system may add the word to the user's unigram dictionary with a count value of one. If the word typed is already in the unigram dictionary, the system may add one to that unigram count value. This also contains the number of times the suggestion was rejected (e.g., the system corrected to this word and the user changed it back to the original word). When the user types a sequence of two words they haven't typed before, add it to their bigram dictionary with a count value of one. If the sequence has been typed before, add one to the bigram count value. If the word is at the start of a sentence, a ‘start-of-sentence’ token is added as the first value.

Inputs to the system may include an initial vocabulary, such as, by way of example, a dictionary for each downloaded language of ˜70-100k common words in each language and the number of times each occurs in a number of common texts in the corresponding language.

The method includes determining, by the virtual keyboard application, that the user has completed entering the word (104). Inputs to the system may include a current word, a previous word and touchpoints of sequence. In some embodiments, when a user types what the system identifies as a stop character, and this input is the word just typed, the word before the previous stop character, and the touchpoints of the entire sequence (previous word+intermediate stop character+current word). The ‘word just typed’ and ‘word before previous stop character’ may be the sequences of characters closest to each touchpoint. For example, if the user types ‘this is’, because they have typed the stop character ‘ ’, the current word is “is”, the previous word is “this” and the entire sequence of touchpoints include all of the touchpoints for “this is”. Stop characters are any characters the system determines signifies that the user is finished typing a word, including, for example, a space, a full stop, a comma, a colon, etc.

The method includes identifying, by the virtual keyboard application, a touchpoint within the graphical user interface associated with the at least one character (106). The method may also include before determining the edit distance, identifying a language in which the user entered the first word.

The method may include before determining the edit distance, determining whether the first word matches a word in the dictionary in the language matching the language of the first word and determining that the first word is not in the dictionary.

The method may include identifying a language in which the user typed the first word; identifying a dictionary that is in the identified language from a plurality of dictionaries stored on the computing device; determining whether the first word matched a word in the identified dictionary; and determining that the first word is not in the identified dictionary.

The method includes accessing, by the virtual keyboard application, at least one word entered by the user prior to the entering of the first word (108).

The method includes determining, by the virtual keyboard application, an edit distance between the first word and each of a plurality of candidate modifications, based on analyzing the first word, the touchpoint and the at least one word entered prior to the entering of the first word, the plurality of candidate modifications selected from a dictionary in a language matching a language of the first word (110). In one embodiment, the method includes selecting the plurality of candidate modifications from a dictionary including words in a dialect of a language. In another embodiment, the method includes selecting the plurality of candidate modifications from a dictionary including a subset of words contained in a second dictionary and associated with a population group having a threshold level of probability of using the subset of words. In another embodiment, the method includes selecting the plurality of candidate modifications from a dictionary including words in a slang version of a language.

A measurement of the difference between two strings within received user input may be referred to as a “vanilla edit distance”. This may be the number of operations to change one string into another string. These operations may include, without limitation, deletion, insertion, substitution or transposition. For example, the edit distance of ‘hlelo’->‘hello’ is 1, because it requires a single character transposition. As another example, the edit distance of ‘thisis’->‘this is’ is 1, because it requires a single space insertion. As a further example, the edit distance of ‘hello’->‘hello’ is 0, because the strings are identical.

A development upon the vanilla edit distance described above may include “Keyboard-weighted edit distance”. The edit distance for this type of distance metric depends on where within the user interface a user touched, upon the keyboard layout, upon the time between touches, and upon the presence of diacritics in either string.

The method includes identifying, by the virtual keyboard application, a subset of the plurality of candidate modifications, each of the subset associated with a confidence score that satisfies a threshold level of confidence (112). In one embodiment, identifying the subset of the plurality of candidate modifications includes executing, by the virtual keyboard application, a neural network component to determine a probability of a candidate modification having a threshold level of accuracy.

In one embodiment, a “vanilla edit” method executes to narrow down suggestions generated by the system prior to providing the initial set of suggestions to a user for autocorrecting a word or phrase. The method may include calculating the “vanilla edit distance” to every candidate word in the vocabulary and keeping only those below a certain maximum edit distance. A maximum edit distance depends on word length; shorter words may have a lower maximum edit distance. Maximum edit distance may depend on the minimum edit distance found. For example, if the input word is ‘hello’, the suggestion ‘hello’ has an edit distance of 0, so the system will only keep words with an edit distance<=1 (minimum found edit distance+1). The system may also consider that the user could have accidentally inserted a stop character (e.g., ‘ele.phant->‘elephant’). For this, the system may calculate the edit distance of the combination [‘previous word’+‘stop character’+‘current word’] to every word in the vocabulary. The system may consider the possibility that the user could have accidentally hit the key neighboring a stop character. For this, the system may calculate the probability of every letter in the word being a stop character (based on the user's touchpoints and probability distribution, as described above). For each split location (defined as each probable stop character) with a probability over a certain threshold, the system may calculate the edit distance to all other words in the vocabulary. If the words at all different split locations are in the dictionary and combine to make a word below the maximum edit distance, the system may add it to a list of suggestions. For example, ‘thisjisjgoing’->‘this is going’ has an edit distance of two, because two spaces were substituted for ‘j’s. Other feature extraction includes:
length of noisy word, suggestion, and previous words;
number of counts of suggestion in the preloaded vocabulary;
number of separate words in the suggestion (e.g., ‘thisis’->‘this is’, means 2 words have been suggested);
language probability;
and how many times the user has ‘undone’ the suggestion (e.g., the system may change ‘ralk’ into ‘talk’ and the user changes the suggestion back to ‘ralk’).
   Neural language model hidden states may include the previous 15 characters (e.g., the “context”), which are first run through the GRU, producing the ‘context’ hidden state vector. Using this as the initial hidden state, each suggestion is then passed through the GRU, with the final hidden state being output.

The system may generate weighted edit distance determinations for certain suggestions (e.g., narrowed down suggestions). For example, the system may determine that the weight of insertion of an apostrophe is lower than insertion of any other character. As another example, the weight of substituting letter_1 for letter_2 with a diacritic (if no swipe is detected) is only slightly higher than substituting for letter_2 without the diacritic. The weight of substituting a letter may depend on the touchpoint location, which may be used to determine the probability of each key being pressed. For example, if the touchpoint is exactly between two characters, the weight of substituting for either character is identical and approximately equal to 0.5. If the touchpoint is very close to the center of the ‘a’ key, but slightly away from it, the weight will be close to, but not exactly, 0. The weight of transposition is reduced if the keys are on different sides of the keyboard, with a weight that depends on time between touches (if the time is very short, the transposition weight is lower.

In some embodiments, the system uses a parameter that biases the word the user actually typed, meaning the system may control the confidence level before an autocorrection is applied. If, for example, the system determines that a user is often undoing the system-applied autocorrection, the system may increase this parameter, thus only providing corrections when a level of confidence exceeds a threshold level of confidence (which may be, for example, a higher threshold level than a default threshold). For an example of this, if the user types the word ‘biden’, which is not in the system's default dictionary, the combination model may determine that the probability that ‘biden’ is the correct word is just 0.4. ‘Bidet’, however, is given a probability of 0.6. If the ‘keep current word’ bias is 0.3, the ‘biden’ probability will be increased to 0.7, and so will be preferred over ‘bidet’ in a subsequent autocorrect process.

Additive smoothing may be used to calculate the n-gram probabilities, in the following equations, K represents a constant smoothing factor, V is the total vocabulary size (length of the user unigrams), C_{T} is the total number of occurrences of all words (sum of user unigram values) and C_{ngram}(x) is the n-gram counts of word x. x|y means x given y, so in the sequences ‘this is’, x=‘is’ and y=‘this’.

$${P}_{u n i g r a m} ( x ) = \frac{{C}_{ngram} ( x ) + K}{{C}_{T} + V \times K}$$

$${P}_{b i g r a m} ( x \vert y ) = \frac{{C}_{bigram} ( x \vert y ) + K}{{C}_{unigram} ( y ) + V \times K}$$

In one embodiment, the system includes a fully connected neural network 210 that combines one or more of the above features to determine a probability of a possible suggestion being the correct suggestion (or of being a suggestion that satisfies a threshold level of accuracy or that is likely to increase a level of accuracy associated with a suggestion). From the suggestions and their corresponding features, the combination model may output scores for each suggestion. The system may then choose to modify a display of a user interface of a virtual keyboard application to include a display of the suggestion with the highest score. The structure of this model may separate the features into two parts. The first part is the hidden state vector. This may be a highly complex, uninterpretable feature, and thus requires a higher degree of non-linearity than the other features. For this reason, the vector is passed through two fully connected neural network layers (with RELU activations), before being combined with the other feature vector. This combination is then passed through a fully connected layer, before the final softmax (sigmoid) layer. The target is 0 if the suggestion is not the correct suggestion and 1 if the suggestion is correct.

In another embodiment, the system may include a separate model used to process the language model hidden state, to output a probability of a sequence given the context. This would replace the extra layers before combination with the feature vector.

The method includes modifying, by the virtual keyboard application, the graphical user interface to include a display of at least one of the identified subset associated with the confidence score that satisfies a threshold level of confidence (114). The method may include receiving user input including an instruction to replace the first word with the at least one of the identified subset. The method may include receiving user input including an instruction not to replace the first word with the at least one of the identified subset. The method may include receiving user input including an instruction to add the first word to the dictionary.

Character-based neural language model may refer to a recurrent neural network (RNN) that tokenizes the input text into characters and then outputs the probability distribution of the proceeding character. This may be used to calculate the probability of proceeding words and the probability of entire sequences. In one embodiment, the system may implement a type of RNN known as a Gated Recurrent Unit (GRU). GRUs function the same as RNNs, except that they have an internal gating mechanism that helps the network know which part of the context are important.

Inputs to the system may include a neural language model. In one embodiment, at the start of a new input sequence, every time a token (e.g., a character) is input to the GRU, the hidden state (a vector inside the GRU cell, which can be thought of as the ‘memory’ of the GRU) is updated based on the weights calculated during the training of the GRU. This hidden state is output after each token and fed back into the GRU. In this way, a language model is created that ‘understands’ the context that came before it. The token can be any character in the language's alphabet, a ‘start-of-sentence’ token, or an ‘unknown’ token if the character isn't in the language's alphabet. In one embodiment, this may be implemented using Tensorflow Lite on Android. In another embodiment, this may be implemented using CoreML on iOS.

Inputs to the system may include an identification of a language probability. A dictionary which has all the user languages may be identified, as well as the probability that the current sentence is in each language.

User keyboards (keys and their corresponding touchpoints and probability distributions) may be dynamically modified. As indicated above, coordinates identifying where on a screen of a device a user touched and whether they swiped whilst pressing (including the movement path along which they swipe), along with the start and end timestamp of the touch, may be referred to as touchpoints. Touchpoints may be associated with one or more characters. The systems and methods described herein may modify the association between a touchpoint and one or more characters—for example, a default touchpoint may indicate an x,y coordinate pair is associated with the letter “a”, but the system may execute a method to modify the x,y coordinate based on where on the screen a user actually touches when the user intends to enter the letter “a.” A preloaded value for use in a method for making such a modification is a dictionary {key: (touchpoint, distribution parameters)}, referred to as the keyboard dictionary. A key may be the specific key on the keyboard (for example the first key is the one in the top left, which is the letter ‘q’ in the English layout, or ‘a’ in the French layout). Distribution parameters may be 2D Gaussian parameters around each key that model where a user can touch when they aim for the center of the given “key”; this may be updated in an online fashion.

Each user may have access to different keyboard dictionaries for each keyboard layout they use (e.g., one for portrait and one for landscape keyboard layout). These dictionaries may then be updated as the user uses each keyboard layout. The system may analyze where on a screen each user touches when they are trying to touch an ‘a’ in a user interface, for example. Over time, the system may move the touchpoint location away from the default value to the average of their touchpoints. If a user types a word and doesn't change it, the system concludes that these touchpoints all correspond to the most probable keys, based on the keyboard dictionary. If a user types a word and the autocorrection changes the word and substitutes any characters, if the user then accepts this correction (e.g., doesn't change it) the system may determine that the touchpoints correspond to the corrected key. Using these touchpoints and keys, the system may move the touchpoint associated with the character away from the default value. For example, the user may typically touch to the left of the ‘a’ key when intending to write the letter ‘a’, and x,y coordinate pair for the location at which the user actually touches the screen becomes the new value. In some embodiments, the application modifies the user interface to display the representation of the character at the location on the screen where the user typically touches when the user intends to input that character. In other embodiments, the application does not modify the user interface but associates the location that the user touches with the character the user intends to touch and, optionally, automatically corrects what the user did input to reflect what the user intended to input.

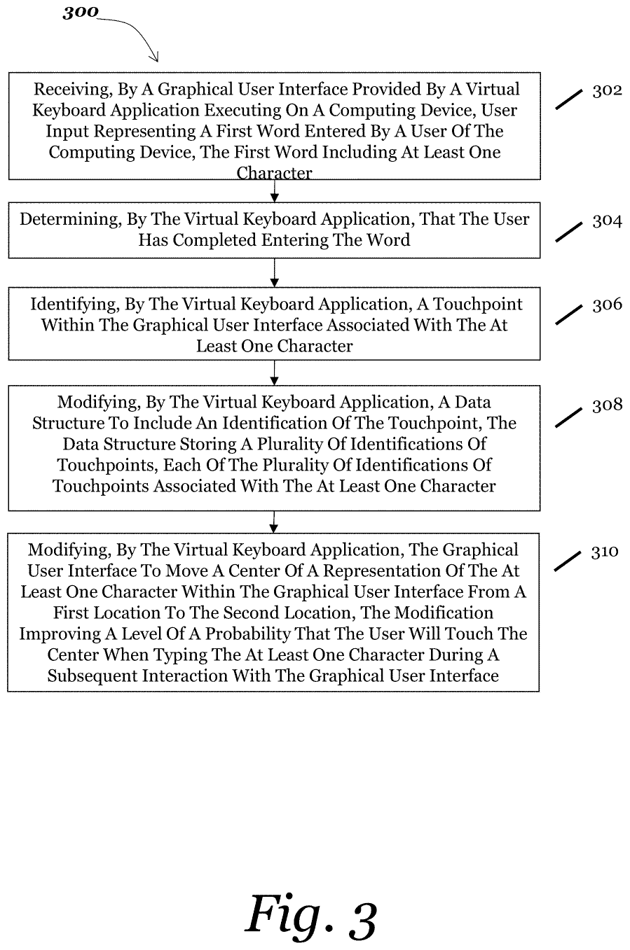

Therefore, and referring now to FIG. 3, a method 300 for modifying a virtual keyboard layout generated by a virtual keyboard application includes receiving, by a graphical user interface provided by a virtual keyboard application executing on a computing device, user input representing a first word entered by a user of the computing device, the first word including at least one character (302). The method includes determining, by the virtual keyboard application, that the user has completed entering the word (304). The method includes identifying, by the virtual keyboard application, a touchpoint within the graphical user interface associated with the at least one character (306). The method includes modifying, by the virtual keyboard application, a data structure to include an identification of the touchpoint, the data structure storing a plurality of identifications of touchpoints, each of the plurality of identifications of touchpoints associated with the at least one character (308). The method includes modifying, by the virtual keyboard application, the graphical user interface to move a center of a representation of the at least one character within the graphical user interface from a first location to the second location, the modification improving a level of a probability that the user will touch the center when typing the at least one character during a subsequent interaction with the graphical user interface (310).

Using these touchpoints and keys, the system may model the distribution of all key-touches as a 2D Gaussian. The system may calculate the covariance matrix (S) of this and mean (m). This allows the system to calculate the probability of the user pressing each key, given a touchpoint (x). To do this, the system may calculate the probability density function of each key using the equation for a multivariate normal distribution and the calculated parameters.

$$P D {F}_{j} = \frac{1}{\sqrt{det ( {\sum }_{j} )}} {e}^{- \frac{1}{2} {( x - {μ}_{j} )}^{T} {Σ}_{j}^{- 1} ( x - {μ}_{j} )}$$

The system may then normalize these densities between all keys so that the total probability is one.

$$= \frac{P D {F}_{j}}{{\sum }_{k} {PDF}_{k}}$$

In some embodiments, the systems and methods described herein may include implementing a weighted Damerau-Levenshtein distance. Although this distance is conventionally implemented to determine as a linear distance between keys, conventional approaches do not typically teach or suggest using such a distance to solve a probabilistic problem or to calculate, given the user's previous key touches, what is the probability of the user having pressed each key given the touchpoint.

The methods and systems described herein may also be used for correcting words entered before the last word typed. For example, the user types:
The shlp sells bread.
   After seeing the first two words, the system may correct shlp to ship. After they type ‘sells’, however, the system may analyze the subsequent input, determine that ‘shop’ would be a more accurate suggestion, and therefore corrects it again to ‘shop’. The system 200 may, therefore, include functionality for saving a word that has been through the autocorrect process and execute the autocorrect process described in FIG. 1A multiple times for the same word.

The methods and systems described herein may provide functionality for identifying a weighted edit distance, in a system in which there are a plurality of language models (e.g., one for each language in which user input may be received), in a system including a combination model. Combining multiple features allows the combination model to decide what inputs are important and if there are any important relationships between the features. For example, the combination model will learn that longer words are more likely to have more typos in them, so it should behave differently to short words. Also, similarly to ensemble models, having two language models with different operating principles allows the application to extract a more reliable prediction.

Referring now to FIGS. 1B and 1n connection with Table 1 below, a flow diagram depicts an embodiment of the inputs and outputs used in the method 100. As shown in FIG. 1B, user n-grams, preloaded vocabulary, user keyboard types, and current words, context, and sequence touchpoints are inputs used in determining a vanilla edit distance, which itself is an input to determining a narrowed-down subset of suggestions and context with touchpoints. Language probability, use statistics, user n-grams, preloaded vocabulary, and the narrowed-down subset of suggestions are inputs to feature extraction functionality, which itself is an input to a combination model that generates probabilities to each suggestions and enables the selection of a suggestion with the highest probabilities. Other inputs to the combination model include n-gram probabilities and neural language models and weighted edit distances.

TABLE 1
Inputs and Outputs

| Input | Output |
|---|---|
| Every word accepted by the user (i.e., they type | User n-grams |
| it and then don't change it, or the system may | |
| autocorrect it and they don't change it) and the | |
| previous context (list of strings) | |
| Touchpoints of every intended key for each | User keyboard (keys, their |
| keyboard layout (dictionary of key: [x, y] | corresponding touchpoints and |
| vector) | multivariate gaussian parameters) |
| All words typed in the current session (list of | Language probability |
| strings) | |
| How many times a word has been shown to the | User statistics |
| user by the language model. | |
| How many times the user has chosen each | |
| word shown by the language model. | |
| How many times a user has undone the | |
| autocorrection suggestion. | |
| Current word (string) | Vanilla edit distance |
| User words (a set of all words typed by the | |
| user) | |
| User keyboard (a dictionary of keys and their | |
| associated touchpoints) | |
| Initial vocabulary (a preloaded set of words, | |
| common to all users) | |
| Typed words, narrowed down suggestions and | Other features |
| context (strings) | |
| Initial vocabulary (a preloaded dictionary of | |
| words and counts, common to all users). | |
| Language probability (dictionary of languages | |
| installed by user, and probability of each being | |
| used in the current session) | |
| User unigrams (dictionary) | |
| Narrowed down suggestions (such as, for | n-gram probabilities |
| example, a list of strings) | |
| Context (strings) | |
| User n-grams (unigram and bigram | |
| dictionaries) | |
| Narrowed down suggestions (such as, for | Neural language model hidden states |
| example, a list of strings) | |
| Context (strings) | |
| Neural language model (TFlite/CoreML) | |
| Narrowed down suggestions (such as, for | Weighted edit distance |
| example, a list of strings) | |
| Context (strings) | |
| Touchpoints (e.g., [x, y] vector for all touches), | |
| start and end timestamp, and movement path | |
| (list of floats) | |
| User keyboard (dictionary of keys with their | |
| corresponding touchpoints and multivariate | |
| Gaussian parameters (2 × 2 covariance matrix | |
| and 2 × 1 mean)) | |
| Narrowed down suggestions (list of strings) | Combination model word probabilities |
| N-gram probabilities (for example, and | |
| without limitation, a list of floats) | |
| Neural language model hidden states (for | |
| example, and without limitation, a 256- | |
| dimensional vector) | |
| Weighted edit distance (float) | |
| Other features (list of floats) | |
| Current word, context, and sequence | Corrected word sequence |
| touchpoints | |
| User n-grams | |
| User keyboard (keys, their corresponding | |
| touchpoints and probability distribution) | |
| Initial vocabulary (with counts) | |
| Neural language model | |
| Language probability | |

In some embodiments, the methods and systems described herein may include execution of a neural network. By way of example, the system may execute a method for training a different neural network for each (human) language that may be received as user input. Databases of text (including of transcribed text) in one or more languages may be used for testing. In one embodiment, the first 90% of sentences are used to train an n-gram model, the next 5% are used to build training data for the neural network (a random 80% of this subset for training and 20% for cross-validation), and the final 5% are used for testing the results.

In some embodiment, the system may include a noise model based on the keyboard layout to insert errors into the training data for training. For this, the correct string is passed through a function that inserts, deletes, transposes or inserts any keyboard character (including spaces and punctuation) at random. A symmetric gaussian is assigned to each key (this may be a multivariate gaussian), and the gaussian is sampled for each intended character. This gives a new touchpoint and a new key. A higher gaussian noise level is used for training compared to testing. For each word in the training corpus, the system may apply the noise model and then run it through the vanilla edit distance calculator, taking every suggestion. For example, the original word might be ‘hello’, which gets corrupted to ‘helol’, providing the suggestions [‘hello’, ‘hell’, ‘he lol’, ‘cello’, etc.]. The various features described above are extracted for each of these suggestions (weighted edit distance, n-gram probabilities, neural language model probabilities etc.), resulting in a feature vector (length may change in the future depending on features used, but in this instance, it is 268×1). If the suggested word is equal to the correct word (which can only happen either one time for each word—i.e., when the suggestion is ‘hello’ in this case), the system may set the label y=1, and for all other cases set the label y=0. The cross-validation data is similarly processed, and the system may elect a neural network that performs best on this data (e.g., exceeds a threshold level of acceptable performance as specified by a user). A single unit sigmoid layer at the output, with the loss function being binary cross entropy and the optimizer ‘Adam’ used with an inverse time decay scheduler may execute until meeting the early stopping criterion that loss doesn't improve for 30 rounds, whereby the best performing epoch is taken. Also, accuracy, precision, recall and AUC are all logged to ensure that the lowest loss will also be the best performing network. The network may be converted into CoreML and TFLite, with no compression necessary because the model size is small and inference speed is fast.

The system may also analyze a number of different metrics, to minimize the chance of there being specific bugs/weak points in execution of the methods; for example, by determining whether a correct word is not included in a dictionary or the system vocabulary, whether a word with a closer edit distance was chosen, whether a word with the same edit distance was chosen, whether a word with a larger edit distance was chosen, whether a “noisy” word is already in a vocabulary, so the autocorrection procedure didn't change it back to the correct word (e.g., ‘hello’ being turned into ‘hell’ by noise), and whether too much noise added (the noise may be configured to be larger than a maximum edit distance, so the word wasn't in the narrowed down suggestions from vanilla edit distance). The system may also look at sentences from a test set and, if the autocorrect fails for a word, “color” the word according to which error occurred.

The methods and systems described herein may therefore provide functionality for identifying a weighted edit distance, in a system in which there are a plurality of language models (e.g., one for each language in which user input may be received), in a system including a fully connected neural network.

In some aspects, the method for generating an autocorrect suggestion may include segmenting, by a first machine learning model, user inputs into separate characters, and assigning, by a machine learning model, a character probability to each character.

Although FIG. 3 described one method described herein is a method for modifying a virtual keyboard layout, other methods are provided, including methods for improving other types of input devices or functionality. That is, the methods and systems described herein are not limited to improving virtual keyboards. In one aspect, the methods and systems described herein provide functionality for improving a user interface within one or more specific types of application (e.g., instead of modifying every user interface available in every application on a computing device, the system may include functionality for improving particular, targeted types of applications, such as an email client or a texting client).

In another aspect, the methods and systems described herein provide functionality for correcting errors in voice transcription applications.

In another aspect, the methods and systems described herein provide functionality for correcting errors in user input received via a physical keyboard, through execution of a method similar to the method described above for the virtual keyboard autocorrect, except that the probability distribution for the weighted Damerau-Levenshtein may be discrete (e.g., there might be no touchpoints—a user either hits the right key or the wrong key).

In another aspect, the methods and systems described herein provide functionality for correcting errors generated through an optical character recognition process (e.g., for hand-writing or scanned documents) through execution of a method similar to the method described above for the virtual keyboard autocorrect, except that the probability distribution for the weighted Damerau-Levenshtein is weighted by the probability over each character. In such an embodiment, the system may begin learning from users to see how they write different letters.

In another aspect, the methods and systems described herein provide functionality for correcting errors generated through brain-computer interfaces.

In another aspect, the methods and systems described herein provide functionality for correcting errors through use of an autocorrection SDK, which may be used in other applications. Such methods may include generation of an estimation of possible key locations on popular (physical desktop) keyboard. Instead of, or in addition to user n-grams, an additional language model may be used that was trained with data from the specific application for which the SDK is to be provided. In this way, the neural network may achieve more accurate results in the application-specific context (e.g., emails) or for a specific user (e.g., a CRM application where often company-specific terms are used). Therefore, the methods and systems described herein may include a computer-implemented method for generating and displaying a recommendation for modification of user input, the method including receiving, by a graphical user interface provided by an application executing on a computing device, user input representing a first word entered by a user of the computing device via a physical keyboard, the first word including at least one character; determining, by the application, that the user has completed entering the word; identifying, by the application, a touchpoint on the physical keyboard associated with the at least one character; accessing, by the application, at least one word entered by the user prior to the entering of the first word; determining, by the application, an edit distance between the first word and each of a plurality of candidate modifications, based on analyzing the first word, the touchpoint, and the at least one word entered prior to the entering of the first word, the plurality of candidate modifications selected from a dictionary in a language matching a language of the first word; identifying, by the application, a subset of the plurality of candidate modifications, each of the subset associated with a confidence score that satisfies a threshold level of confidence; and modifying, by the application, the graphical user interface to include a display of at least one of the identified subset associated with the confidence score that satisfies a threshold level of confidence.

In some embodiments, the methods and systems described herein may provide functionality that uses data input and machine learning not only for autocorrection purposes but also to identify a specific user. In a keyboard context, the application may use information like touchpoints, words typed, and word-combinations typed to determine if the same user is using the device as the user that typically enters the data into the device. This could be used to lock the device when suspicious behavior is noticed. This functionality could also work with other types of interfaces.

In some embodiments, the system includes non-transitory, computer-readable medium comprising computer program instructions tangibly stored on the non-transitory computer-readable medium, wherein the instructions are executable by at least one processor to perform the methods described above.

It should be understood that the systems described above may provide multiple ones of any or each of those components and these components may be provided on either a standalone machine or, in some embodiments, on multiple machines in a distributed system. The phrases ‘in one embodiment,’ ‘in another embodiment,’ and the like, generally mean that the particular feature, structure, step, or characteristic following the phrase is included in at least one embodiment of the present disclosure and may be included in more than one embodiment of the present disclosure. Such phrases may, but do not necessarily, refer to the same embodiment. However, the scope of protection is defined by the appended claims; the embodiments mentioned herein provide examples.

The terms “A or B”, “at least one of A and/or B”, “at least one of A and B”, “at least one of A or B”, or “one or more of A and/or B” used in the various embodiments of the present disclosure include any and all combinations of words enumerated with it. For example, “A or B”, “at least one of A and B” or “at least one of A or B” may mean (1) including at least one A, (2) including at least one B, (3) including either A or B, or (4) including both at least one A and at least one B.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, SCALA, PYTHON, TYPESCRIPT, or any compiled or interpreted programming language.

Each such computer program may be implemented in a computer program product tangibly embodied in a machine-readable storage device for execution by a computer processor. Method steps may be performed by a computer processor executing a program tangibly embodied on a computer-readable medium to perform functions of the methods and systems described herein by operating on input and generating output. Suitable processors include, by way of example, both general and special purpose microprocessors. Generally, the processor receives instructions and data from a read-only memory and/or a random-access memory. Storage devices suitable for tangibly embodying computer program instructions include, for example, all forms of computer-readable devices, firmware, programmable logic, hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data (including, for example, instructions for storage on non-transitory computer-readable media) from a second computer providing access to the programs via a network transmission line, wireless transmission media, signals propagating through space, radio waves, infrared signals, and so on.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, Python, Rust, Go, or any compiled or interpreted programming language.

Each such computer program may be implemented in a computer program product tangibly embodied in a machine-readable storage device for execution by a computer processor. Method steps may be performed by a computer processor executing a program tangibly embodied on a computer-readable medium to perform functions of the methods and systems described herein by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or grayscale pixels on paper, film, display screen, or other output medium. A computer may also receive programs and data (including, for example, instructions for storage on non-transitory computer-readable media) from a second computer providing access to the programs via a network transmission line, wireless transmission media, signals propagating through space, radio waves, infrared signals, etc.

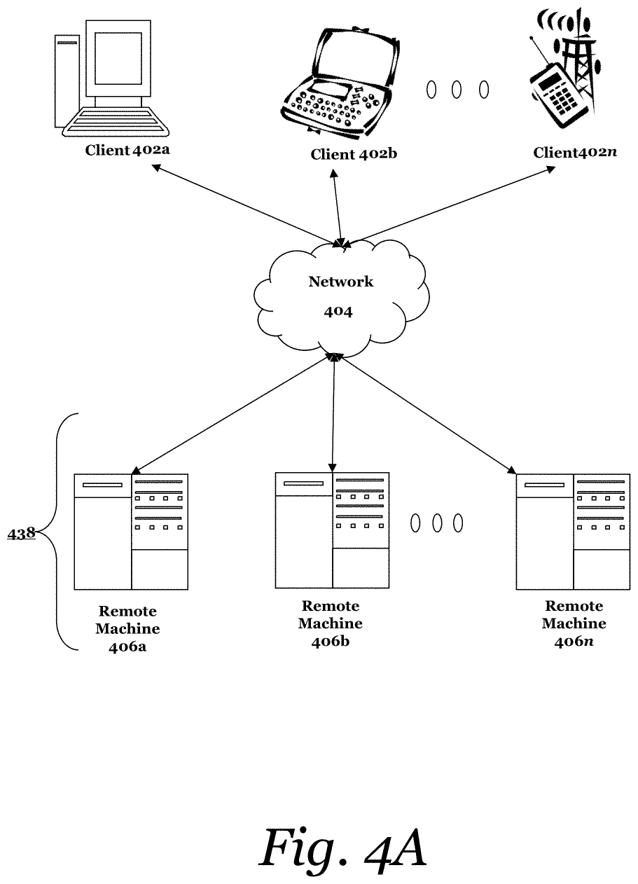

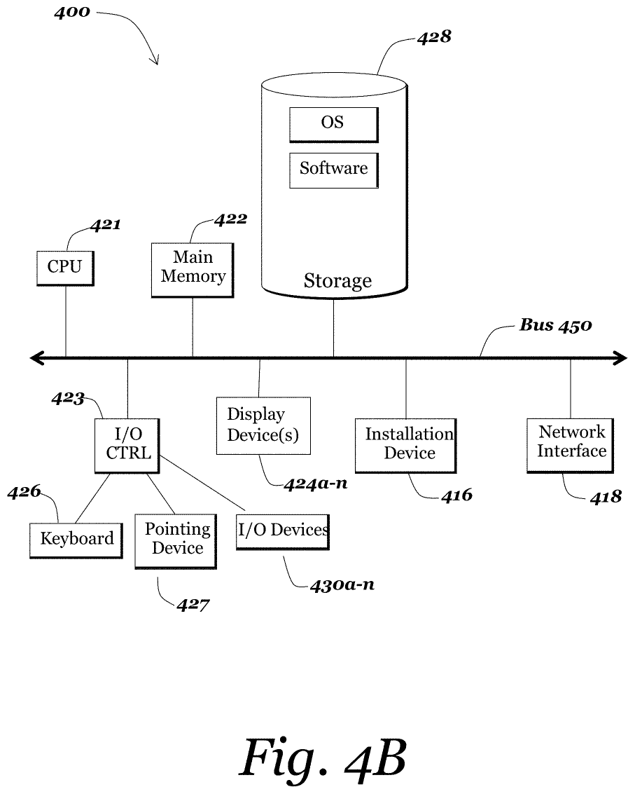

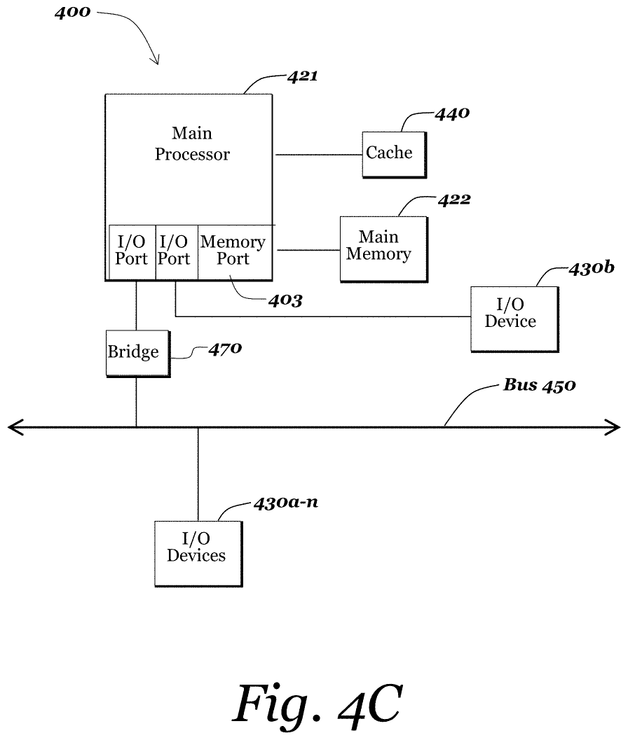

Referring now to FIGS. 4A, 4B, and 4C, block diagrams depict additional detail regarding computing devices that may be modified to execute novel, non-obvious functionality for implementing the methods and systems described above.

Referring now to FIG. 4A, an embodiment of a network environment is depicted. In brief overview, the network environment comprises one or more clients 402a-402n (also generally referred to as local machine(s) 402, client(s) 402, client node(s) 402, client machine(s) 402, client computer(s) 402, client device(s) 402, computing device(s) 402, endpoint(s) 402, or endpoint node(s) 402) in communication with one or more remote machines 406a-406n (also generally referred to as server(s) 406 or computing device(s) 406) via one or more networks 404.

Although FIG. 4A shows a network 404 between the clients 42 and the remote machines 406, the clients 402 and the remote machines 406 may be on the same network 404. The network 404 can be a local area network (LAN), such as a company Intranet, a metropolitan area network (MAN), or a wide area network (WAN), such as the Internet or the World Wide Web. In some embodiments, there are multiple networks 404 between the clients 402 and the remote machines 406. In one of these embodiments, a network 404′ (not shown) maybe a private network and a network 404 may be a public network. In another of these embodiments, a network 304 may be a private network and a network 404′ a public network. In still another embodiment, networks 404 and 404′ may both be private networks. In yet another embodiment, networks 404 and 404′ may both be public networks.

The network 404 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, a wireline network, an Ethernet, a virtual private network (VPN), a software-defined network (SDN), a network within the cloud such as AWS VPC (Virtual Private Cloud) network or Azure Virtual Network (VNet), and a RDMA (Remote Direct Memory Access) network. In some embodiments, the network 404 may comprise a wireless link, such as an infrared channel or satellite band. The topology of the network 404 may be a bus, star, or ring network topology. The network 404 may be of any such network topology as known to those ordinarily skilled in the art capable of supporting the operations described herein. The network may comprise mobile telephone networks utilizing any protocol or protocols used to communicate among mobile devices (including tables and handheld devices generally), including AMPS, TDMA, CDMA, GSM, GPRS, UMTS, or LTE. In some embodiments, different types of data may be transmitted via different protocols. In other embodiments, the same types of data may be transmitted via different protocols.

A client 402 and a remote machine 406 (referred to generally as computing devices 400 or as machines 400) can be any workstation, desktop computer, laptop or notebook computer, server, portable computer, mobile telephone, mobile smartphone, or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client 402 may execute, operate or otherwise provide an application, which can be any type and/or form of software, program, or executable instructions, including, without limitation, any type and/or form of web browser, web-based client, client-server application, an ActiveX control, a JAVA applet, a webserver, a database, an HPC (high performance computing) application, a data processing application, or any other type and/or form of executable instructions capable of executing on client 402.

In one embodiment, a computing device 406 provides functionality of a web server. The web server may be any type of web server, including web servers that are open-source web servers, web servers that execute proprietary software, and cloud-based web servers where a third party hosts the hardware executing the functionality of the web server. In some embodiments, a web server 406 comprises an open-source web server, such as the APACHE servers maintained by the Apache Software Foundation of Delaware. In other embodiments, the web server executes proprietary software, such as the INTERNET INFORMATION SERVICES products provided by Microsoft Corporation of Redmond, Wash., the ORACLE IPLANET web server products provided by Oracle Corporation of Redwood Shores, Calif., or the ORACLE WEBLOGIC products provided by Oracle Corporation of Redwood Shores, Calif.

In some embodiments, the system may include multiple, logically-grouped remote machines 406. In one of these embodiments, the logical group of remote machines may be referred to as a server farm 438. In another of these embodiments, the server farm 438 may be administered as a single entity.

FIGS. 4B and 4C depict block diagrams of a computing device 400 useful for practicing an embodiment of the client 302 or a remote machine 406. As shown in FIGS. 4B and 4C, each computing device 400 includes a central processing unit 421, and a main memory unit 422. As shown in FIG. 4B, a computing device 400 may include a storage device 428, an installation device 416, a network interface 418, an I/O controller 423, display devices 424a-n, a keyboard 426, a pointing device 427, such as a mouse, and one or more other I/O devices 430a-n. The storage device 428 may include, without limitation, an operating system and software. As shown in FIG. 4C, each computing device 400 may also include additional optional elements, such as a memory port 403, a bridge 470, one or more input/output devices 430a-n (generally referred to using reference numeral 430), and a cache memory 440 in communication with the central processing unit 421.

The central processing unit 421 is any logic circuitry that responds to and processes instructions fetched from the main memory unit 422. In many embodiments, the central processing unit 421 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; those manufactured by International Business Machines of White Plains, N.Y.; or those manufactured by Advanced Micro Devices of Sunnyvale, Calif. Other examples include RISC-V processors, SPARC processors, ARM processors, and processors for mobile devices. The computing device 300 may be based on any of these processors, or any other processor capable of operating as described herein.

Main memory unit 422 may be one or more memory chips capable of storing data and allowing any storage location to be directly accessed by the microprocessor 421. The main memory 422 may be based on any available memory chips capable of operating as described herein. In the embodiment shown in FIG. 4B, the processor 421 communicates with main memory 422 via a system bus 450. FIG. 4C depicts an embodiment of a computing device 400 in which the processor communicates directly with main memory 422 via a memory port 403. FIG. 4C also depicts an embodiment in which the main processor 421 communicates directly with cache memory 440 via a secondary bus, sometimes referred to as a backside bus. In other embodiments, the main processor 421 communicates with cache memory 440 using the system bus 450.

In the embodiment shown in FIG. 4B, the processor 421 communicates with various I/O devices 430 via a local system bus 450. Various buses may be used to connect the central processing unit 421 to any of the I/O devices 430, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 424, the processor 421 may use an Advanced Graphics Port (AGP) to communicate with the display 424. FIG. 4C depicts an embodiment of a computing device 400 in which the main processor 321 also communicates directly with an I/O device 430b via, for example, HYPERTRANSPORT, RAPIDIO, or INFINIBAND communications technology.

One or more of a wide variety of I/O devices 430a-n may be present in or connected to the computing device 400, each of which may be of the same or different type and/or form. Input devices include keyboards, mice, trackpads, trackballs, microphones, scanners, cameras, and drawing tablets. Output devices include video displays, speakers, inkjet printers, laser printers, 3D printers, and dye-sublimation printers. The I/O devices may be controlled by an I/O controller 423 as shown in FIG. 4B. Furthermore, an I/O device may also provide storage and/or an installation medium 416 for the computing device 400. In some embodiments, the computing device 400 may provide USB connections (not shown) to receive handheld USB storage devices such as the USB Flash Drive line of devices manufactured by Twintech Industry, Inc. of Los Alamitos, Calif.

Referring still to FIG. 4B, the computing device 400 may support any suitable installation device 416, such as a floppy disk drive for receiving floppy disks such as 3.5-inch, 5.25-inch disks or ZIP disks; a CD-ROM drive; a CD-R/RW drive; a DVD-ROM drive; tape drives of various formats; a USB device; a hard-drive or any other device suitable for installing software and programs. In some embodiments, the computing device 400 may provide functionality for installing software over a network 404. The computing device 400 may further comprise a storage device, such as one or more hard disk drives or redundant arrays of independent disks, for storing an operating system and other software. Alternatively, the computing device 400 may rely on memory chips for storage instead of hard disks.

Furthermore, the computing device 400 may include a network interface 318 to interface to the network 404 through a variety of connections including, but not limited to, standard telephone lines, LAN or WAN links (e.g., 802.11, T1, T3, 56 kb, X.25, SNA, DECNET, RDMA), broadband connections (e.g., ISDN, Frame Relay, ATM, Gigabit Ethernet, Ethernet-over-SONET), wireless connections, virtual private network (VPN) connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, 802.15.4, Bluetooth, ZIGBEE, CDMA, GSM, WiMax, and direct asynchronous connections). In one embodiment, the computing device 400 communicates with other computing devices 400′ via any type and/or form of gateway or tunneling protocol such as GRE, VXLAN, IPIP, SIT, ip6tnl, VTI and VTI6, IP6GRE, FOU, GUE, GENEVE, ERSPAN, Secure Socket Layer (SSL) or Transport Layer Security (TLS). The network interface 418 may comprise a built-in network adapter, network interface card, PCMCIA network card, card bus network adapter, wireless network adapter, USB network adapter, modem, or any other device suitable for interfacing the computing device 400 to any type of network capable of communication and performing the operations described herein.

In further embodiments, an I/O device 430 may be a bridge between the system bus 450 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 400 of the sort depicted in FIGS. 4B and 4C typically operates under the control of operating systems, which control scheduling of tasks and access to system resources. The computing device 400 can be running any operating system such as any of the versions of the MICROSOFT WINDOWS operating systems, the different releases of the UNIX and LINUX operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7, WINDOWS 8, WINDOWS VISTA, and WINDOWS 10 all of which are manufactured by Microsoft Corporation of Redmond, Wash.; MAC OS manufactured by Apple Inc. of Cupertino, Calif.; OS/2 manufactured by International Business Machines of Armonk, N.Y.; Red Hat Enterprise Linux, a Linux-variant operating system distributed by Red Hat, Inc., of Raleigh, N.C.; Ubuntu, a freely-available operating system distributed by Canonical Ltd. of London, England; CentOS, a freely-available operating system distributed by the centos.org community; SUSE Linux, a freely-available operating system distributed by SUSE, or any type and/or form of a Unix operating system, among others.

Having described certain embodiments of methods and systems for modifying user input processes, it will be apparent to one of skill in the art that other embodiments incorporating the concepts of the disclosure may be used.

What is claimed is:

1. A computer-implemented method for generating and displaying a recommendation for modification of user input, the method comprising
receiving, by a graphical user interface provided by a virtual keyboard application executing on a computing device, user input representing a first word entered by a user of the computing device, the first word including at least one character;
determining, by the virtual keyboard application, that the user has completed entering the word;
identifying, by the virtual keyboard application, a touchpoint within the graphical user interface associated with the at least one character;
accessing, by the virtual keyboard application, at least one word entered by the user prior to the entering of the first word;
determining, by the virtual keyboard application, an edit distance between the first word and each of a plurality of candidate modifications, based on analyzing the first word, the touchpoint, and the at least one word entered prior to the entering of the first word, the plurality of candidate modifications selected from a dictionary in a language matching a language of the first word;
identifying, by the virtual keyboard application, a subset of the plurality of candidate modifications, each of the subset associated with a confidence score that satisfies a threshold level of confidence; and
modifying, by the virtual keyboard application, the graphical user interface to include a display of at least one of the identified subset associated with the confidence score that satisfies a threshold level of confidence.

2. The method of claim 1 further comprising selecting the plurality of candidate modifications from a dictionary including words in a dialect of a language.

3. The method of claim 1 further comprising selecting the plurality of candidate modifications from a dictionary including a subset of words contained in a second dictionary and associated with a population group having a threshold level of probability of using the subset of words.

4. The method of claim 1 further comprising selecting the plurality of candidate modifications from a dictionary including words in a slang version of a language.

5. The method of claim 1, wherein identifying the subset of the plurality of candidate modifications further comprises executing, by the virtual keyboard application, a neural network component to determine a probability of a candidate modification having a threshold level of accuracy.

6. The method of claim 1, wherein determining the edit distance further comprises determining a weighted edit distance.

7. The method of claim 1 further comprising, before determining the edit distance, identifying a language in which the user entered the first word.

8. The method of claim 1 further comprising:
before determining the edit distance, determining whether the first word matches a word in the dictionary in the language matching the language of the first word; and
determining that the first word is not in the dictionary.

9. The method of claim 1 further comprising, before determining the edit distance:
identifying a language in which the user typed the first word;
identifying a dictionary that is in the identified language from a plurality of dictionaries stored on the computing device;
determining whether the first word matched a word in the identified dictionary; and
determining that the first word is not in the identified dictionary.

10. The method of claim 1 further comprising receiving user input including an instruction to replace the first word with the at least one of the identified subset.

11. The method of claim 1 further comprising receiving user input including an instruction not to replace the first word with the at least one of the identified subset.

12. The method of claim 1 further comprising receiving user input including an instruction to add the first word to the dictionary.

13. A computer-implemented method of modifying a virtual keyboard layout generated by a virtual keyboard application, the method comprising:
receiving, by a graphical user interface provided by a virtual keyboard application executing on a computing device, user input representing a first word entered by a user of the computing device, the first word including at least one character;
determining, by the virtual keyboard application, that the user has completed entering the word;
identifying, by the virtual keyboard application, a touchpoint within the graphical user interface associated with the at least one character;
modifying, by the virtual keyboard application, a data structure to include an identification of the touchpoint, the data structure storing a plurality of identifications of touchpoints, each of the plurality of identifications of touchpoints associated with the at least one character; and
modifying, by the virtual keyboard application, the graphical user interface to move a center of a representation of the at least one character within the graphical user interface from a first location to the second location, the modification improving a level of a probability that the user will touch the center when typing the at least one character during a subsequent interaction with the graphical user interface.
